(19) United States
(12) Patent Application Publication
(10) Pub. No.: US 2008/0289271 A1
(43) Pub. Date: Nov. 27, 2008

(54) COMPLIANT MOUNTING FOR OPTICAL COMPONENT

(75) Inventors: Wayne Miller, Los Altos, CA (US); Pete Young, San Francisco, CA (US)

Correspondence Address: Trellis Intellectual Property Law Group, PC, 1900 EMBARCADERO ROAD, SUITE 109, PALO ALTO, CA, 94303, US

(73) Assignee: SOL FOCUS, INC., Palo Alto, CA (US)

(21) Appl. No.: 11/753,516

(22) Filed: May 24, 2007

(51) Int. Cl. E04D 13/18; F21V 21/00

(52) U.S. Cl. 52/173.3; 248/220.21

(57) ABSTRACT

In one embodiment, a first mount is coupled to a first panel. A first compliant member is then placed on an optical component. The optical component and first compliant member are then placed on the first mount. For example, the optical component and the first compliant member are placed on a ledge of the first mount and a cylinder of the first mount may pass through the aperture. Also, one side of the first compliant member touches the first mount. A second mount is then placed on top of the other surface of the first compliant member. The front panel and a second compliant member are then placed on a front side of the optical component to secure the optical component in the optical system.

### BACKGROUND

Particular embodiments generally relate to a compliant mounting and more specifically to a compliant mounting for an optical component.

In an optical system, an optical component may be attached to a front panel or window using an adhesive. This holds the optical component in place. For example, in a solar panel, a glass mirror may be attached to a front panel using a glue-like substance.

Using the adhesive to adhere the optical component to the front panel requires that equipment be used to align the optical component to a correct position with respect to the front panel. For example, the optical component may need to be aligned such that a photovoltaic cell in an optical system is correctly aligned with the optical component and front panel when the optical system is assembled. Further, when glue is used to adhere the optical component to the front panel, the glue needs time to set. This requires specialized tooling or extra equipment to hold the optical component and front panel in place while the glue sets. The tooling needed to adhere the optical component to the front panel is costly. Further, the optical component is fragile and extreme care must be taken while adhering the optical component to the front panel. And once the optical component is adhered to the front panel, extreme care should be taken in handling the panel because of the fragility of the optical component. Also, a special type of glue may need to be used to ensure the optical component does not break when slight movement of the optical system occurs. Accordingly, the glue may also add substantial cost to the optical system.

### SUMMARY

In one embodiment, a first mount is coupled to a first panel. A first compliant member is then placed on an optical component. For example, the optical component may be a glass mirror for an optical system, such as a solar power generation system. The optical component and first compliant member are then placed on the first mount. For example, the optical component and the first compliant member are placed on a ledge of the first mount and a cylinder of the first mount may pass through the aperture. Also, one side of the first compliant member touches the first mount. A second mount is then placed on top of the other surface of the first compliant member. For example, the second mount may be locked with the cylinder, which secures the optical component in between the first and second mounts. The front panel and a second compliant member are then placed on a front side of the optical component to secure the optical component in the optical system.

In one embodiment, an optical system for generating solar power is provided. The optical system comprises: a first panel; a compliant system attached to an optical component; and a second panel, wherein the compliant system provides compliance to the optical component when the optical component is secured in between the first panel and the second panel in the optical system, the compliant system being secured to the optical component without using an adhesive substance between the compliant system and the optical component.

In another embodiment, a method for producing a solar power optical system is provided. The method comprises: providing a first panel and a second panel; and positioning an optical component between the first panel and the second panel, the optical component being secured in the optical system using a compliant system without using an adhesive substance to adhere the compliant system to the optical component.

In yet another embodiment, a method for manufacturing an optical system is provided. The method comprises: coupling a first mount to a first panel; coupling a first compliant member to an optical component; placing a second mount on a second side of the compliant member to hold the optical component with respect to the first panel in the optical system, wherein a first side of compliant member is configured to be placed on the first mount; and coupling a second compliant member to a second panel and placing the second compliant member on an end of the optical component, the second compliant member holding the optical component with respect to the second panel in the optical system, wherein the first and second compliant members provide compliance to the optical component in the optical system.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts an example of an optical system according to one embodiment.

FIG. 2 depicts an example of a first mount.

FIGS. 3A and 3B show an example of a first compliant member.

FIG. 4 shows an example of second compliant members 104.

FIG. 5 shows an example of a plurality of optical components when placed in the optical system.

FIG. 6 depicts a simplified flow chart of a method for manufacturing optical system 100.

### DETAILED DESCRIPTION OF THE EMBODIMENTS

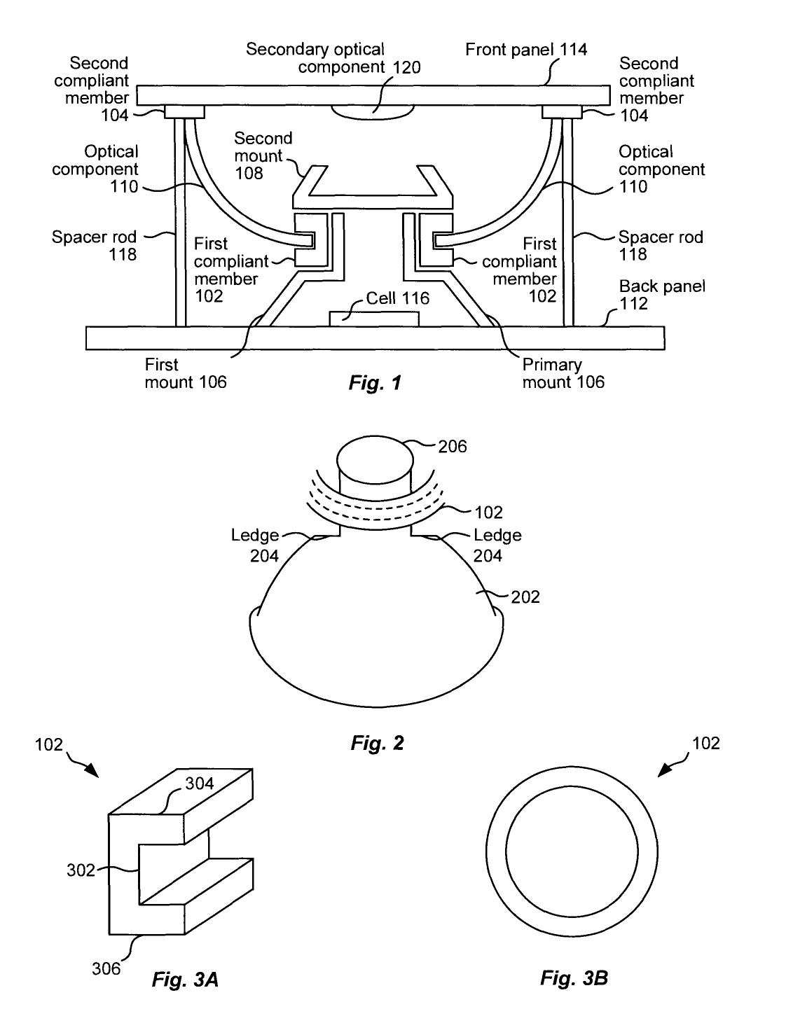

FIG. 1 depicts an example of an optical system 100 according to one embodiment. A mounting scheme for an optical component 110 is provided. Optical component 110 may be secured in optical system 100 using a first mount 106 and a second mount 108. In one embodiment, optical component 110 is secured in optical system 100 without using an adhesive substance that contacts a surface of optical component 110. The mounting scheme provides a safe and compliant mounting for optical component 110. Further, the mounting scheme controls the position of optical component 110 and may align it with respect to a cell 116. A compliant system may be used to mount optical component 110 in optical system. The compliant system may include a first compliant member 102 and second compliant members 104; however, different numbers of compliant members may be used.

Optical component 110 may be any optical device. For example, optical component 110 may be a mirror. A mirror may be made of a fragile material, such as glass. The fragileness of optical component 110 may need to be taken into account in the mounting scheme. For example, some compliance may need to be provided in the mounting such that slight movements during assembly or in the final product will not break optical component 110.

In one embodiment, optical component 110 may be part of a solar power generation system. For example, optical component 110 may reflect electromagnetic radiation. In one example, the electromagnetic radiation is reflected by optical component 110 to a secondary optical component 120, which then focuses the electromagnetic radiation to a cell 116. Cell 116 may be a photovoltaic cell that is configured to facilitate converting the electromagnetic radiation to electricity. Although this description of a solar power generation system is described, it will be understood that other configurations will be appreciated.

The electromagnetic radiation, such as light, may shine through front panel 114. Front panel 114 may be made of glass or any other material that allows light to pass through it. Back panel 112 may form the back support for optical system 100. Side panels (not shown) secure back panel 112 and front panel 114 together to form optical system 100. It should be noted that although only one optical component 110 is shown, it will be understood that any number of optical components 110 may be provided in optical system 100 (e.g. an array of optical components 110 may be provided).

First mount 106 may be made of a rigid material. For example, first mount 106 may be made of a metal, rigid plastic, etc. Although first mount 106 is described as being made of a rigid material, it will be understood that first mount 106 may be made of another material, such as compliant material.

First mount 106 allows a first compliant member 102 to be placed on it. For example, first mount 106 provides a ledge in which first compliant member 102 may be placed on. By placing, first compliant member 102 is not attached to first mount 106 using an adhesive. FIG. 2 depicts a more detailed example of first mount 106. As shown, a base 202 of first mount 106 is circular. However, it will be understood that base 202 may be any shape, such as a square shape, triangular shape, etc. As shown, a ledge 204 is provided in which first compliant member 102 may sit. Further, a cylinder 206 is provided. This cylinder 206 allows light to shine through first mount 106 to cell 116. Also, cylinder 206 may also allow second mount 108 to attach to it and secure optical component 110, which may be described in more detail below.

Referring back to FIG. 1, a first compliant member 102 may be in the form of a U-shape in a cross-section view. When viewed from above, first compliant member 102 may be of an O-shape, such as an O-ring or gasket. First compliant member 102 is custom-designed to fit inside an aperture of optical component 110 and protects the inside edge of optical component 110.

FIGS. 3A and 3B show a more detailed embodiment of first compliant member 102. As shown, a middle area 302 provides a space such that optical component 110 may be inserted into it. Upper area 304 and lower area 306 cover a portion of optical component 110. For example, as shown in FIG. 1, upper portion 304 may cover a top portion of optical component 110 and lower portion 306 may cover a lower portion of optical component 110. By inserting optical component 110 into middle area 302, first compliant member 102 is secured onto optical component 110. For example, in FIG. 3B, an O-ring is shown that can be inserted in an aperture of optical component 110. Other shapes may also be appreciated, such as square, triangular, etc. In one embodiment, as long as middle area (i.e., the interior groove) is included in first compliant member 102, any shape can be used. Middle area 302 allows first compliant member 102 to be attached to optical component 110 without using an adhesive.

A second mount 108 is provided to secure optical component 110 in optical system 100. In one example, second mount 108 is made of a rigid substance, such as a metal or plastic. In other embodiments, second mount 108 may be made of a material that provides some compliance. In one example, second mount 108 may attach to first mount 106, such as by attaching to cylinder 206. Second mount 108 may then lock on to first mount 106 using a locking mechanism. For example, the locking mechanism may be a mechanism in which a latch is used to lock second mount 108 on to first mount 106. In this case, a hole may be provided in second mount 108 that is fitted over a latch in first mount 106. Second mount 108 may be turned to lock the latch on to second mount 108. Also, other mechanisms may be appreciated. For example, second mount 108 may be pushed onto first mount 106 and snapped into a locking position on first mount 106. Second mount 108 may also be configured to be a shield for optical component 110. That is, optical component 110 may be shielded from light at certain angles.

First mount 106 and second mount 108 secure optical component 110. For example, the aperture of optical component 110 fits around cylinder 206 to secure it. First compliant member 102 provides compliance to optical component 110 when it is secured in first mount 106 and second mount 108. For example, because first compliant member 102 is made of a compliant substance, optical component 110 may be able to withstand slight movement of optical system 100 without being damaged. This is important because optical component 110 may be made of a fragile material and fixing a damaged optical component 110 in optical system 100 is costly and time consuming.

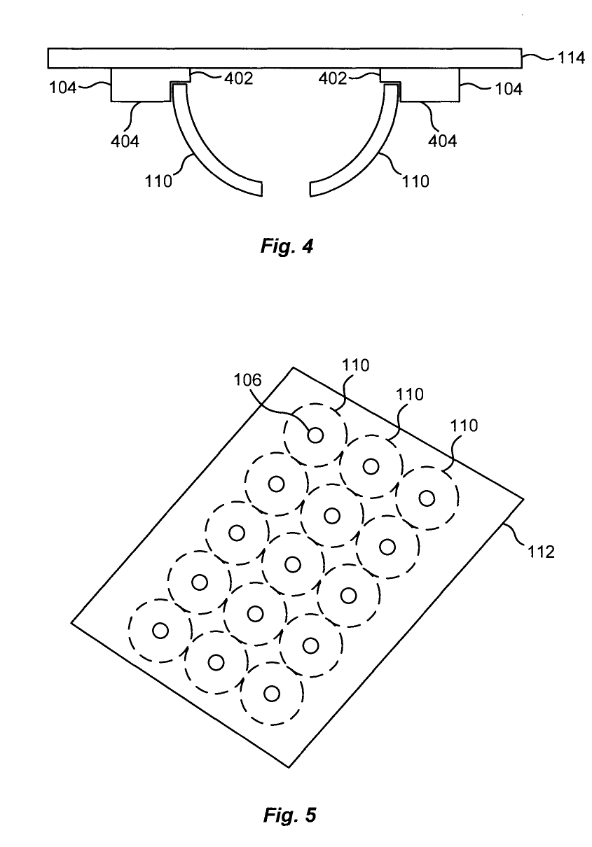

One or more second compliant members 104 are also provided to secure optical component 110 to front panel 114 at a second end of optical component 110. Second compliant member 104 may also be made of a compliant material, such as similar material as first compliant member 102. FIG. 4 shows a more detailed example of second compliant members 104. Any number of second compliant members 104 may be provided. For example, optical component 110 may have multiple ends, such as four. Second compliant members 104 may be placed on each end.

As shown, an overhang 402 is provided in addition to a base 404. Overhang 402 and base 404 secure optical component 110 when front panel 114 is placed on top of second compliant member 104. For example, optical component 110 fits in between base 404 and overhang 402 and when front panel 114 is secured to second compliant member 104, optical component 110 may be secured in system 100. Movement is inhibited by having optical component 110 in between base 404 and overhang 402.

In one example, second compliant member 104 may be in the shape of a triangle. This shape may be provided such that an array of optical components 110 may be securely fit in optical system 100 with each other. Although a triangle is discussed, it will be understood that other shapes may be provided, such as circular shapes, square shapes, hexagonal shapes, etc.

Referring back to FIG. 1, front panel 114 may be secured to second compliant member 104. In one embodiment, second compliant member is secured to front panel 114 using an adhesive substance. For example, glue may be used to adhere front panel 114 to second compliant member 104. However, although an adhesive substance is described, it will be understood that an adhesive substance may not be used. For example, grooves in front panel 114 that fit the shape of second compliant member 104 may be used to attach second compliant member 104 to front panel 114. Further, the securing of front panel 114 to back panel 112 in optical system 100 using side panels may be sufficient to hold second compliant member 104. In one embodiment, if an adhesive is used, the adhesive is not used to adhere optical component 110 to second compliant member 104 or front panel 114. Rather, second compliant member 104 is adhered to front panel 114.

The use of optical system 100 eliminates the need to use glue to position optical component 110 in optical system 100. This also eliminates any equipment needed to hold optical component 110 in place while the glue sets or dries. This allows front panel 114 to be manufactured separately from optical component 110. That is, optical component 110 does not need to be adhered directly to front panel 114 until optical system 100 is assembled. Thus, until front panel 114 needs to be placed in optical system 100 to form the system with side panels and back panel 112, no interaction with optical component 110 is needed. The assembly of front panel 114 without optical component 110 enables automated handling of front panel 114, which reduces manufacturing costs and labor, and improves quality.

As mentioned above, first compliant member 102 and second compliant member 104 provide compliance for optical component 110. Accordingly, slight movements may be absorbed without damaging optical component 110. The design of first compliant member 102 and second compliant member 104 allow for compliance in the X, Y, and Z directions. For example, because first compliant member 102 surrounds an aperture of optical component 110, compliance in the Z direction is provided in that optical component 110 may move back and forth. Also, compliance is provided in the XY direction in that optical component 110 may move sideways and upwards.

A spacer rod 118 may also be provided in optical system 100. This rod 118 may provide support and also provides dimensional control and structure between back panel 112 and front panel 114. Spacer rod 118 is positioned between front panel 114 and the back panel 112 at the same location as second compliant member 104 to provide structure and insure optical component 110 does not take any significant loading.

The use of the mounting scheme for optical system 100 also provides alignment and positional accuracy for optical component 110. For example, it may be important that optical component 110 is aligned in optical system 100 because accurate reflection of light is needed to focus it onto cell 116. Optical component 110 may also be aligned with respect to a secondary mirror that may be found on front panel 114. By fixing first mount 106 on back panel 112, a position in which optical component 110 will be mounted may be predicted. This may be important when optical system 100 includes multiple optical components 110. FIG. 5 shows an example of a plurality of optical components 110 when placed in optical system 100. As shown, a plurality of optical components are provided with a plurality of first mount 106. First mount 106 may be secured on back panel 112 at a desired position. Optical components 110 may then be placed or fitted on first mount 106. Because the positioning of first mount 106 is known, then optical components 110 will fit in the array as desired. For example, they may be aligned as desired.

Also, optical component 110 should be aligned with secondary optical component 120. In one example, second compliant member 104 may be used to align optical component 110 and secondary optical component 120. Second compliant member 104 may be adhered to front panel 114 at positions such that when it is placed on optical component 110, proper alignment results. Further, second compliant member 104 may be placed on optical component 110 such that when front panel 114 is placed at the proper position above second compliant member 104, proper alignment is provided. Also, a combination of placing second compliant member 104 on front panel 114 and optical component 110 may be used.

In one embodiment, no rigid material or metal is touching a surface of optical component 110. For example, first compliant member 102 provides compliance between optical component 110 and first mount 106/second mount 108. Further, second compliant member 104 provides compliance between front panel 114 and optical component 110. Thus, support is provided using first mount 106, second mount 108, and front panel 114. However, compliance is provided by first compliant member 102 and second compliant member 104. Thus, support is provided in addition to providing compliance. The support and compliance is also provided without using an adhesive on a surface between optical component 110 and first compliant member 102 and also on a surface between optical component 110 and second compliant member 104.

Particular embodiments provide many advantages. For example, glue does not need to be used to adhere optical component 110 to any other components. Thus, time may be saved in waiting for the glue to set. Also, costs may be saved in providing equipment to hold optical component 110 in place and in the cost of the glue itself. Further, once optical component 110 is placed in optical system 100, it is fragile, and thus care must be used in handling the system. Because particular embodiments do not need to adhere optical component 110 to back panel 112 or front panel 114, optical component 110 does not need to be placed in optical system 100 until final assembly. This may allow faster and automated assembly of parts of optical system 100. Also, compliance is provided by first compliant member 102 and second compliant member 104. This allows optical component 110 to absorb slight movements in optical system 100 without being damaged.

Further, positioning and alignment may be provided using first mount 106 and second compliant member 104. Thus, once optical component 110 is placed on first mount 106, it is positioned as desired in optical system 100. Once second compliant member 104 and front panel 114 are placed on optical component 110, front panel 114 is placed as desired. For example, secondary optical component 120 may be placed in a desired position with respect to optical component 110.

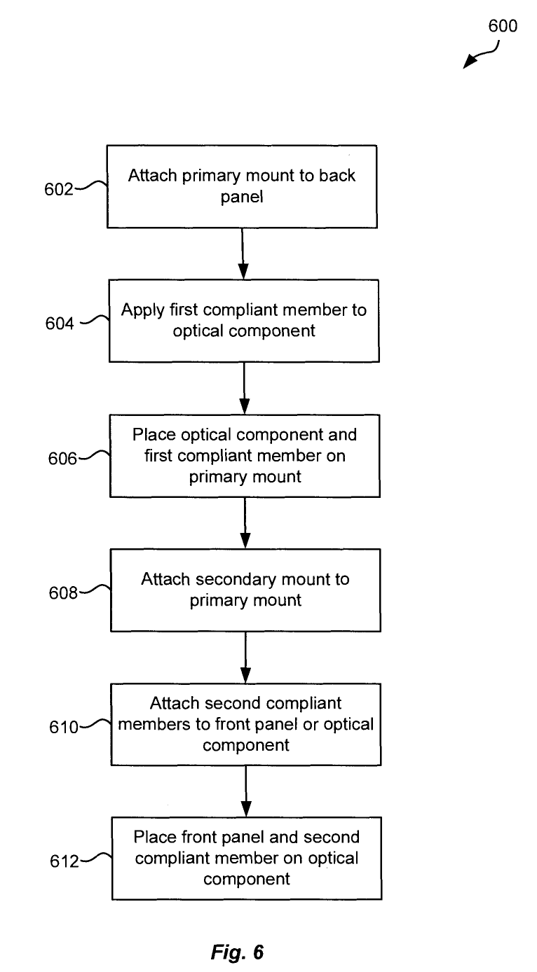

FIG. 6 depicts a simplified flow chart 600 of a method for manufacturing optical system 100. Step 602 attaches first mount 106 to back panel 112. First mount 106 may be attached to back panel 112 using any process and in addition is aligned on back panel 112 to provide proper alignment for optical component 110 in the final system.

Step 604 applies first compliant member 102 to optical component 110. For example, an O-ring (gasket) may be fitted into an aperture for optical component 110.

Step 606 places optical component 110 and first compliant member 102 on first mount 106. For example, optical component 110 and first compliant member 102 may be placed on a ledge of first mount 106.

Step 608 attaches second mount 108 to first mount 106. For example, second mount 108 may be placed on top of first compliant member 102 and is locked to first mount 106. This may create effectively a sandwich of second mount 108 and first mount 106 with first compliant member 102 and optical component 110 in between.

Step 610 attaches second compliant members 104 to front panel 114 or optical component 110. For example, second compliant member 104 may be adhered to front panel 114.

Step 612 places front panel 114 and second compliant member 104 on optical component 110. Accordingly, optical component 110 may be held in place once front panel 114 is placed on top of optical component 110 using second compliant member 104. When optical system 100 is secured using side panels, front panel 114 and back panel 112 may be secured. This holds optical component 110 in optical system 100.

Although the description has been described with respect to particular embodiments thereof, these particular embodiments are merely illustrative, and not restrictive. Although a solar power generation system is described, it will be understood that optical system 100 may be used for other purposes.

In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated particular embodiments, including what is described in the Abstract, is not intended to be exhaustive or to limit the invention to the precise forms disclosed herein. While specific particular embodiments of, and examples for, the invention are described herein for illustrative purposes only, various equivalent modifications are possible within the spirit and scope, as those skilled in the relevant art will recognize and appreciate. As indicated, these modifications may be made to the present invention in light of the foregoing description of illustrated particular embodiments and are to be included within the spirit and scope.

Thus, while the present invention has been described herein with reference to particular embodiments thereof, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit. It is intended that the invention not be limited to the particular terms used in following claims and/or to the particular embodiment disclosed as the best mode contemplated for carrying out this invention, but that the invention will include any and all particular embodiments and equivalents falling within the scope of the appended claims.

We claim:

1. An optical system for generating solar power, the optical system comprising:
a first panel;
a compliant system attached to an optical component; and
a second panel, wherein the compliant system provides compliance to the optical component when the optical component is secured in between the first panel and the second panel in the optical system, the compliant system being secured to the optical component without using an adhesive substance between the compliant system and the optical component.

2. The optical system of claim 1, wherein the compliant system comprises a first compliant member and a second compliant member, the first compliant member attaching to the optical component at a first area and the second compliant member attaching to the optical component at a second area.

3. The optical system of claim 2, wherein the second compliant member is configured to be attached to the second panel and to be placed on an end of the optical component, the second compliant member configured to hold the optical component with respect to the second panel in the optical system.

4. The optical system of claim 1, further comprising a first mount configured to be attached to the first panel, wherein a compliant member of the compliant system is placed on the first mount.

5. The optical system of claim 4, further comprising a second mount, wherein the second mount is configured to be placed on the first mount to hold the optical component in the optical system.

6. The optical system of claim 5, wherein the first mount and second mount comprise a rigid material for supporting the optical component.

7. The optical system of claim 5, wherein the second mount is configured to lock with the first mount to secure the optical component using a locking mechanism.

8. The optical system of claim 1, further comprising a spacer rod configured to be positioned between the first panel and the second panel.

9. A method for producing a solar power optical system, the method comprising:
providing a first panel and a second panel; and
positioning an optical component between the first panel and the second panel, the optical component being secured in the optical system using a compliant system without using an adhesive substance to adhere the compliant system to the optical component.

10. The method of claim 9, further comprising placing a first mount on the first panel, wherein the first mount is configured to align the optical component in the optical system.

11. The method of claim 10, further comprising placing a first compliant member from the compliant system on the first mount, wherein the first compliant member is attached to a first area of the optical component.

12. The method of claim 11, further comprising placing a second mount on the first mount to secure the optical component in the optical system, wherein a portion of the first compliant member is positioned in between the first mount and the second mount to provide compliance to the optical component.

13. The method of claim 10, further comprising attaching a second compliant member in the compliant system to the second panel, the second compliant member attached to a second area of the optical component.

14. The method of claim 9, further comprising placing a plurality of optical components using a plurality of compliant systems in a pattern in the optical system.

15. The method of claim 10, further comprising placing a spacer rod positioned between the first panel and the second panel.

16. A method for manufacturing an optical system, the method comprising:
coupling a first mount to a first panel;
coupling a first compliant member to an optical component;
placing a second mount on a second side of the compliant member to hold the optical component with respect to the first panel in the optical system, wherein a first side of compliant member is configured to be placed on the first mount; and
coupling a second compliant member to a second panel and placing the second compliant member on an end of the optical component, the second compliant member holding the optical component with respect to the second panel in the optical system, wherein the first and second compliant members provide compliance to the optical component in the optical system.

17. The method of claim 16, further comprising coupling a plurality of side members to the first panel and second panel.

18. The method of claim 16, wherein the first compliant member is coupled to the optical component and the second compliant member is coupled to the optical component without using an adhesive substance.

19. The method of claim 16, wherein the first mount is configured to align the optical component when the first compliant member coupled to the optical component is placed on the first mount.

20. The method of claim 16, wherein the second compliant member is configured to align the second panel with the optical component when the second compliant member is coupled to the second panel and the optical component.
